(19) United States
(12) Patent Application Publication
(10) Pub. No.: US 2008/0034640 A1
(43) Pub. Date: Feb. 14, 2008

(54) Removable, reusable, strike indicator for fishing

(76) Inventors: Tor-Erik Naerheim, Thousand Oaks, CA (US); Yngve Naerheim, Thousand Oaks, CA (US)

Correspondence Address: YNGVE NAERHEIM, 1577 KIRK AVE., THOUSAND OAKS, CA, 91360, US

(21) Appl. No.: 11/462,113

(22) Filed: Aug. 3, 2006

(51) Int. Cl. A01K 93/00

(52) U.S. Cl. 43/44.92; 43/44.87; 43/44.89

(57) ABSTRACT

A reusable strike indicator of size and weight that is useful in fly fishing, ice fishing and bait fishing, which can be attached without slippage at any location along a leader or fishing line. The strike indicator comprises two solid and watertight half spheres affixed to a bridge that is hinged in the middle allowing it to be closed and secured by a snap locking mechanism at both ends so that the two half spheres form a sphere. The fishing line is clamped between the two halves of the bridge adjacent to the hinge securing the strike indicator to a fishing line. The snap can be opened and closed repeatedly to move the strike indicator to selected positions along the fishing line or to another fishing line without removing the fly or lure.

### BACKGROUND OF THE INVENTION

This invention relates to strike indicators and fishing floats used in fly fishing and fishing with bait or lures, or any other form of fishing where a lightweight, removable and reusable float or strike indicator is desirable.

Fly fishermen often use a wet fly that sinks after the fly is cast into water as do bait and lures. The purpose of a strike indicator is to alert a fisherman, during the short interval a fish has a fly, bait or lure in its mouth, that a fish has taken the fly, bait or lure so the fisherman can set the hook. In order to detect the lightest strike of a fish, it is essential that strike indicator be as light as possible. A lightweight strike indicator is also essential to minimize its influence on the casting characteristics of a fly line. The strike indicator must also be sufficiently buoyant not to be submerged by the churning of turbulent water. In addition to the requirements mentioned above, a strike indicator must; 1) not weaken the leader or fishing line by abrasions or kinks, 2) be movable to a different position along the line without having to cut the fishing line or remove the fly or lure, and 3) not leave adhesive residue on the line. It is also desirable that a strike indicator is not comprised of separate, multiple components that will render it useless if one or more are lost or damaged. A strike indicator should also be reusable.

None of the available strike indicators satisfy all requirements listed above.

One type of adhesive-backed foam strike indicator, although it is lightweight and floats, is affixed to the fishing line with an adhesive. It is not reusable, leave sticky residue on the fishing line, and when wet may not stick to the line.

One type of strike indicator is made of wood, cork, or polystyrene foam. It is typically cylindrical with a bore through the long axis through which the fishing line is passed and held in place by a toothpick type pin wedged into the bore. Loss of either renders the strike indicator useless. It also cannot be attached to a fishing line without removing the fly or lure. A modified version has a longitudinal slit enabling the strike indicator to be slipped over a fishing line without removing the fly or lure. However, the slit weakens the main body, making it prone to splitting in two pieces, due to the jamming action of the “toothpick” rendering it useless.

Another type of strike indicator has an axial bore. It works by passing a loop of fishing line through the bore of the strike indicator and running the end of the line through the loop and pulling tightly. This will permanently kink and weaken the fishing line.

Floating devices used for heavier fishing such as one described in Bondhus U.S. Pat. No. 3,744,176 is too heavy for fly fishing and the fly or lure must be removed from the end of the fishing line in order to attach or remove the strike indicator.

The strike indicator described in Halterman, Jr U.S. Pat. No. 5,216,831 consists of three separate components. Two components are made from a floating material which are held together with an elastic rubber band. Loosing one of the three components renders the strike indicator useless. Since rubber bands deteriorate both in elasticity and strength with time and exposure to heat it has limited useful life. This strike indicator is also difficult to see when fishing in fast-flowing water as it tends to become submerged by the turbulence.

### SUMMARY OF THE INVENTION AND ADVANTAGES

The present invention relates to a fish strike indicator which can be positioned anywhere along a fishing leader or line without having to remove the fly or lure from the line, and can maintain its position on the leader when the fly or lure is cast. It consists of only one component designed so it can be folded around a fishing line and snapped together creating enough friction to prevent it from sliding during casting or while in the water. It is removable and reusable and can be made in many different sizes suitable for light fly fishing to heavier bait and lure fishing.

### BRIEF DESCRIPTION OF THE DRAWINGS

FIG. 1 is a tree dimensional view of the strike indicator attached to a fishing line;

FIG. 2 shows an expanded three-dimensional view of the strike indicator with the key features indicated by numbers.

### DETAILED DESCRIPTION OF THE PREFERRED EMBODIMENT

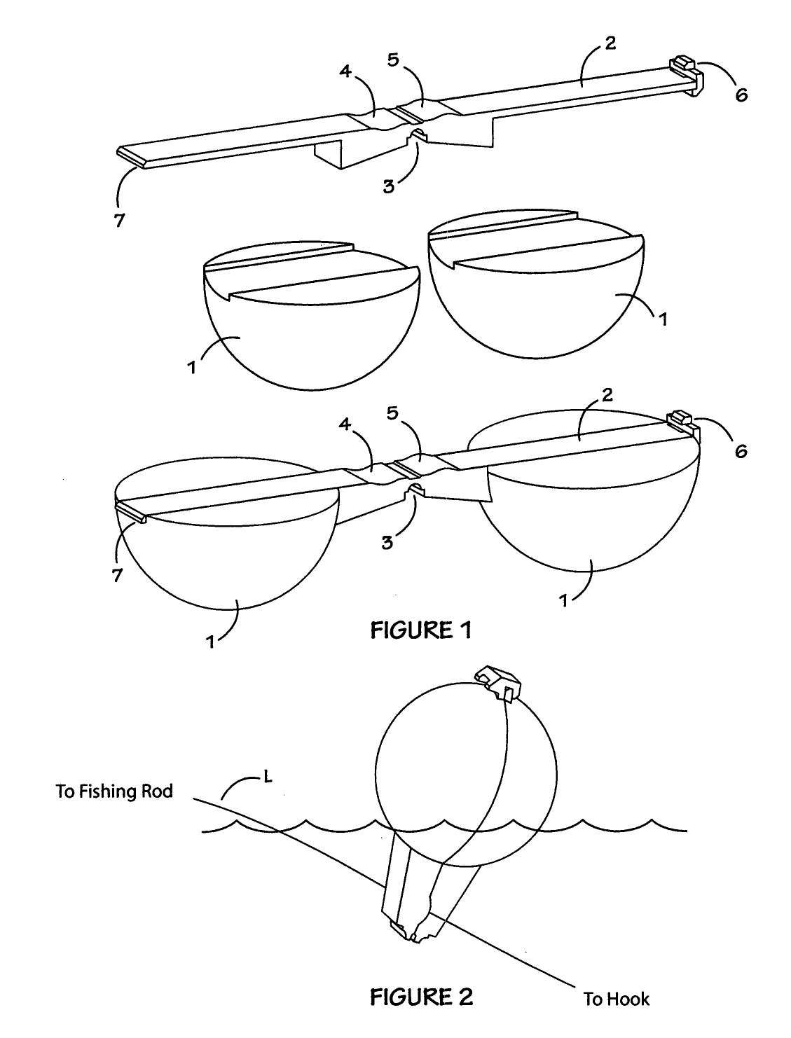

A typical embodiment of the strike indicator is illustrated in FIG. 1 and FIG. 2. The following description refers to FIG. 1. The strike indicator comprises two half spheres (1) permanently affixed to a bridge (2) that is flexible in the middle (3) allowing the two sides with the half spheres (1) to be folded together to form a sphere. Next to the flexible hinge (3) are two mating areas (4) and (5) between which a fishing line (L) is passed. The ridge (5) is slightly higher than the depth of groove (4) to ensure compressive force between them. At the extreme opposite ends of the bridge (2) are two corresponding components (6) and (7) of a latch mechanism. When the bridge is folded over 180 degrees to make a sphere the latch mechanism engages to hold the half spheres together and clamp the strike indicator to the fishing line between the ridge (5) and groove (4). Any latch that can easily be opened and closed repeatedly will work. The particular latch mechanism shown consists of a flexible hook (6) that snaps over on edge (7) on the mating part at the opposite end of the bridge.

The strike indicator is installed on a fishing line by placing it over the line (L), FIG. 2, and snapping the two halves together. It is removed by disengaging the flexible hook (6) from the edge (7).

The two half spheres (1) provide the main buoyancy of the strike indicator and are made of a low-density material such as polystyrene foam. Cork or other low-density materials could be substituted for polystyrene foam. The bridge (2) is made from a thermoplastic polymer that can be repeatedly bent and flexed in the “hinge” (3) and hook (6) areas. The half spheres are permanently bonded to the bridge. Hence, the strike indicator described in this invention consists of only one body with no auxiliary parts that would render a strike indicator useless if any of the parts were damaged or lost.

The buoyancy elements (1) can be of any shape but a streamlined sphere provide low casting resistance that does not snag easily.

The novel features of the invention are that it comprises only one body and that it can be snapped on and off a fishing line at any location along the line without damaging the line or removing the fly or lure.

The strike indicator described in this invention can be manufactured in many different sizes suitable for light fly fishing to heavy bait or lure fishing.

What is claimed is:

1. A removable, reusable strike indicator for fishing comprising:
a body that can be removable and repeatedly snapped together around a fishing line, said body comprised of two cooperating elements connected via a flexible hinge adapted to be fitted together by a latching mechanism to form the body.

2. The strike indicator as defined in claim 1 wherein the cooperative elements provide a location between the two elements enabling the strike indicator to be secured to the fishing line.

3. The strike indicator as defined in claim 1 wherein the two cooperative elements are interlocked by squeezing them together to engage a latching mechanism.

4. The strike indicator as defined in claim 1 wherein the two cooperative elements can be separated by disengaging the latching mechanism.

5. The strike indicator as defined in claim 1 wherein each of the two cooperative elements consist of an assembly of two components, one of which is common to both.

6. (canceled)

7. (canceled)

8. The strike indicator as defined in claim 1 wherein the said elements are made of any material of lower density than water such as wood, cork, plastic, polystyrene foam or a combination of such materials.

9. (canceled)

10. (canceled)
